(19) United States
(12) Patent Application Publication
(10) Pub. No.: US 2026/0338994 A1
(43) Pub. Date: Oct. 29, 2026

(54) ARTIFICIAL INTELLIGENCE (AI)-BASED DETECTION AND PREVENTION OF SELLER MANIPULATION OF BUYERS

(71) Applicant: eBay Inc., San Jose, CA (US)

(72) Inventors: Shiwam Mittal, Santa Clara, CA (US); Rahul Ajaykumar Agarwal, Santa Clara, CA (US)

(21) Appl. No.: 19/188,278

(22) Filed: Apr. 24, 2025

Related U.S. Application Data
(63) Continuation of application No. 18/908,688, filed on Oct. 7, 2024, now Pat. No. 12,320,950.
Application No. 18/908,688 is a continuation of application No. 18/625,469, filed on Apr. 3, 2024, now Pat. No. 12,313,815.
Application No. 18/625,469 is a continuation of application No. 18/524,110, filed on Nov. 30, 2023, now Pat. No. 12,352,923.
Application No. 18/524,110 is a continuation of application No. 18/240,299, filed on Aug. 30, 2023, now Pat. No. 11,874,435.
Application No. 18/240,299 is a continuation of application No. 17/984,103, filed on Nov. 9, 2022, now Pat. No. 11,789,181.
(60) Provisional application No. 63/356,583, filed on Jun. 29, 2022.
(60) Provisional application No. 63/306,472, filed on Feb. 3, 2022.

(51) Int. Cl. G02B 1/04; B29C 64/112; B33Y 10/00; B33Y 70/00; B33Y 80/00; B29K 23/00; B29K 25/00

(52) U.S. Cl. CPC G02B 1/041; B29C 64/112; B33Y 10/00; B33Y 70/00; B33Y 80/00; B29K 2023/00; B29K 2025/06

(57) ABSTRACT

Artificial intelligence (AI)-based detection and prevention of seller manipulation of buyers on an online marketplace is described. A system may intercept a message that a seller of an item is sending to a buyer of the item on the online marketplace. The system may generate a context for the message based on data associated with the seller, the context including the history of the seller’s messages and other past behaviors related to transactions. A large language model (LLM) that is trained to classify intentions of messages may classify the seller’s message as manipulative based on the generated context and the content of the message itself. Because the message is classified as manipulative, the system may prevent the message from being sent to the buyer.

### BACKGROUND

Online marketplaces support and thus experience numerous and varied activities that facilitate transactions on the online marketplace. Some such activities may include a user (e.g., a seller) posting a listing of an item for sale, and a second user (e.g., a buyer) purchasing the item. The online marketplace allows for direct seller-to-buyer communications after a transaction, for example, if the seller has a question about the shipping address. However, this may create opportunities for sellers to send manipulative messages, such as messages that influence buyers to cancel orders, revise feedback, accept alternative items, or perform other actions that would advantage the seller in some way.

### SUMMARY

An artificial intelligence (AI)-based system for detecting and preventing seller manipulation of buyers is leveraged for an online marketplace. In one or more implementations, users may transact on an online marketplace, e.g., a buyer may purchase an item listed for sale on the online marketplace by the seller. The online marketplace may support a messaging interface that allows for direct communications between the buyer and the seller post-transaction. To detect and prevent manipulative messages sent from the seller to the buyer, the AI-based system may intercept messages sent from the seller to the buyer. The system may generate a context associated with a given message based on data associated with the seller. For example, the data may include the seller’s chat history, the relevant item listing, the seller’s order fulfillment and cancellation history (e.g., how often the seller cancels orders), past seller behavior metrics, item bidding history on the seller’s page, the seller’s shipping to location history, and so forth.

A large language model (LLM) trained to classify the intention of messages may determine whether the message from the seller is manipulative based on the generated context and the content of the message itself. If the LLM classifies the message as non-manipulative, then the system may allow the seller to send the message to the buyer. Alternatively, if the LLM classifies the message as manipulative, then customer service may intervene. In such cases, a human customer service agent (e.g., a global communication expert (GCX)) or a customer service bot (e.g., a chatbot) may discuss the message with the seller. When the seller has modified the message enough that the message is no longer manipulative, the customer service agent or bot may allow the message to be sent to the buyer. If the message remains manipulative, then the system may prevent the message from being sent at all.

This Summary introduces a selection of concepts in a simplified form that are further described below in the Detailed Description. As such, this Summary is not intended to identify essential features of the claimed subject matter, nor is this Summary intended to be used as an aid in determining the scope of the claimed subject matter.

### BRIEF DESCRIPTION OF THE DRAWINGS

The detailed description is described in the accompanying figures.

FIG. 1 is an illustration of an environment in an example implementation that is operable to employ techniques described herein.

FIG. 2 depicts an example of a process for AI-based detection and prevention of seller manipulation of buyers in accordance with aspects of the present disclosure.

FIG. 3 depicts a procedure in an example implementation of AI-based detection and prevention of seller manipulation of buyers in accordance with the aspects of the present disclosure.

FIG. 4 illustrates an example of a system that includes an example computing device that is representative of one or more computing systems and/or devices that may implement the various techniques described herein.

### DETAILED DESCRIPTION

### Overview

An AI-based system for detecting and preventing seller manipulation of buyers on an online marketplace is described. In accordance with the described techniques, items may be available (e.g., listed) for sale on the online marketplace. The online marketplace may be accessible by decentralized computing devices that correspond to “clients” of the online marketplace, e.g., users that have accounts with the online marketplace. Users of the online marketplace may have some control over which items they list with or purchase from the online marketplace. For example, the users may determine when to list or purchase items, and may do so from different locations via a website or mobile application for the online marketplace. When a seller posts a lists an item for sale, the seller may include information about the item such as a title, a description, images and any other relevant information.

A buyer may purchase an item from the seller on the online marketplace. After the transaction, the buyer and seller may communicate via a messaging interface on the online marketplace, e.g., to communicate about order updates. In some cases, however, the seller may try to manipulate the buyer through messages, such as to protect the seller’s ratings or maximize the seller’s profits. For example, the seller may send a message that convinces the buyer to cancel the transaction if the seller believes a different buyer will pay more for that item. Alternatively, the message may manipulate the buyer to achieve higher seller ratings, pressure the buyer to avoid returning items by exaggerating costs or offering partial refunds, promise future benefits for compliance, or coerce buyers to leave positive feedback using urgency and emotional appeals.

Such seller manipulation erodes buyer trust, distorts fairness, and undermines the reliability of ratings and reviews on the online marketplace. In addition, sellers with limited stock may often prioritize higher paying buyer’s which may deprive initial buyers of fair opportunities. There are currently no methods for monitoring and deterring such seller manipulation.

To address these limitations, techniques for AI-based detection and prevention of seller manipulation of buyers are described. In one or more implementations, the described techniques involve an LLM trained to classify the intention of messages, which is implemented for an online marketplace. After a transaction has occurred between the buyer and the seller, the system may intercept a message from a seller being sent to a buyer. The system may generate a context associated with the message based on data associated with the seller. For example, the data may include the seller’s chat history, the relevant item listing, the seller’s order fulfillment and cancellation history (e.g., how often the seller cancels orders), past seller behavior metrics, item bidding history on the seller’s page, the seller’s shipping to location history, and so forth.

The LLM may classify the message as manipulative or non-manipulative based on the generated context and the content of the message itself. If the LLM classifies the message as non-manipulative, then the system may allow the seller to send the message to the buyer. Alternatively, if the LLM classifies the message as manipulative, then customer service may intervene. In such cases, a human customer service agent (e.g., a GCX) or a customer service bot (e.g., a chatbot) may discuss the message with the seller and instruct the seller to modify the message. When the message is no longer manipulative, the customer service agent or bot may allow the seller to send the message to the buyer. If the message remains manipulative, then the system may prevent the message from being sent at all.

The described techniques may result in several improvements, including enhanced graphical user interface (GUI) features, faster processing, and improved data storage and data retrieval efficiency, among other improvements. Unlike standard messaging monitoring systems, the described AI-based system utilizes numerous types of contextual data to classify messages as manipulative, which improves the validity and accurateness of the LLM. The contextual data is also gathered and stored in categories specific to a user and a transaction (e.g., the seller’s chat history, the item listing, and so forth), which improves data storage and the efficiency of data retrieval and utilization by the LLM.

Moreover, instead of relying on manual review of each message, the system automatically intercepts and evaluates messages, resulting in faster processing. This enhances operational efficiency by automating detection of manipulation, reducing the need for manual dispute resolution, and supports customer service agents by providing detailed insights. Such real-time evaluation also improves processing speed over other systems that use periodic monitoring or post-action review. Additionally, the use of the contextual data allows the LLM to dynamically adapt based on dynamic seller behavior and other relevant information. The described techniques create a more accurate, robust, and scalable system that consistently intervenes with seller manipulation. This ultimately protects buyers, promotes seller accountability, maintains platform integrity, and drives long-term growth of the online marketplace.

In some aspects, the techniques described herein relate to a computer-implemented method including: receiving a message from a first user for sending to a second user on an online marketplace; generating context for the message based on a set of data associated with the first user; classifying, by an LLM trained to classify an intention of messages, the message as manipulative based on content of the message and the context; and preventing the message from being sent to the second user based on classifying the message as manipulative.

In some aspects, the techniques described herein relate to a computer-implemented method, further including: providing the message for processing by a customer service agent based on classifying the message as manipulative; and determining, by the customer service agent, whether the message is properly classified as manipulative.

In some aspects, the techniques described herein relate to a computer-implemented method, further including: receiving, from the customer service agent, input permitting the message to be sent to the second user; and sending the message to the second user based on the input.

In some aspects, the techniques described herein relate to a computer-implemented method, further including: disabling communications between the first user and the second user based on classifying the message as manipulative; and reenabling the communications between the first user and the second user based in the input permitting the message to be sent.

In some aspects, the techniques described herein relate to a computer-implemented method, wherein determining whether the message is properly classified as manipulative further includes communicating, by the customer support agent, with the first user regarding the message.

In some aspects, the techniques described herein relate to a computer-implemented method, wherein the set of data comprises at least one of a chat history of the first user, item listing information associated with the first user, a cancellation history of the first user, past behavior metrics of the first user, an item bidding history associated with the first user, or shipping information associated with the first user.

In some aspects, the techniques described herein relate to a computer-implemented method, wherein the message is classified as manipulative based on the set of data indicating past manipulative behavior by the second user.

In some aspects, the techniques described herein relate to a computer-implemented method, wherein classifying the message as manipulative further includes determining, by the LLM, a value that represents a level of manipulation of the message, wherein the value is a score or a percentage.

In some aspects, the techniques described herein relate to a computer-implemented method, wherein the first user and the second user are involved in a transaction on the online marketplace, and wherein the message is regarding the transaction.

In some aspects, the techniques described herein relate to a system including: one or more processors; and memory storing instructions that, when executed by the one or more processors, cause the system to: receive a message from a first user for sending to a second user on an online marketplace; generate context for the message based on a set of data associated with the first user; classify, by a large language model (LLM) trained to classify an intention of messages, the message as manipulative based on content of the message and the context; and prevent the message from being sent to the second user based on classifying the message as manipulative.

In some aspects, the techniques described herein relate to a system, wherein the instructions further cause the system to provide the message for processing by a customer service agent based on classifying the message as manipulative; and determine, by the customer service agent, whether the message is properly classified as manipulative.

In some aspects, the techniques described herein relate to a system, wherein the instructions further cause the system to receive, from the customer service agent, input permitting the message to be sent to the second user; and send the message to the second user based on the input.

In some aspects, the techniques described herein relate to a system, wherein the instructions further cause the system to disable communications between the first user and the second user based on classifying the message as manipulative; and reenable the communications between the first user and the second user based in the input permitting the message to be sent.

In some aspects, the techniques described herein relate to a system, wherein the instructions to determine whether the message is properly classified as manipulative further cause the system to communicate, by the customer service agent, with the first user regarding the message.

In some aspects, the techniques described herein relate to a system, wherein the set of data comprises at least one of a chat history of the first user, item listing information associated with the first user, a cancellation history of the first user, past behavior metrics of the first user, an item bidding history associated with the first user, or shipping information associated with the first user.

In some aspects, the techniques described herein relate to a system, wherein the message is classified as manipulative based on the set of data indicating past manipulative behavior by the second user.

In some aspects, the techniques described herein relate to a system, wherein the instructions to classify the message as manipulative further cause the system to determine, by the LLM, a value that represents a level of manipulation of the message, wherein the value is a score or a percentage.

In some aspects, the techniques described herein relate to a system, wherein the first user and the second user are involved in a transaction on the online marketplace, and wherein the message is regarding the transaction.

In some aspects, the techniques described herein relate to a non-transitory computer-readable media storing instructions that, when executed by one or more processors, cause the one or more processors to perform operations including: receiving a message from a first user for sending to a second user on an online marketplace; generating context for the message based on a set of data associated with the first user; classifying, by a large language model (LLM) trained to classify an intention of messages, the message as manipulative based on content of the message and the context; and preventing the message from being sent to the second user based on classifying the message as manipulative.

In the following discussion, an exemplary environment is first described that may employ the techniques described herein. Examples of implementation details and procedures are then described which may be performed in the exemplary environment as well as other environments. Performance of the exemplary procedures is not limited to the exemplary environment and the exemplary environment is not limited to performance of the exemplary procedures.

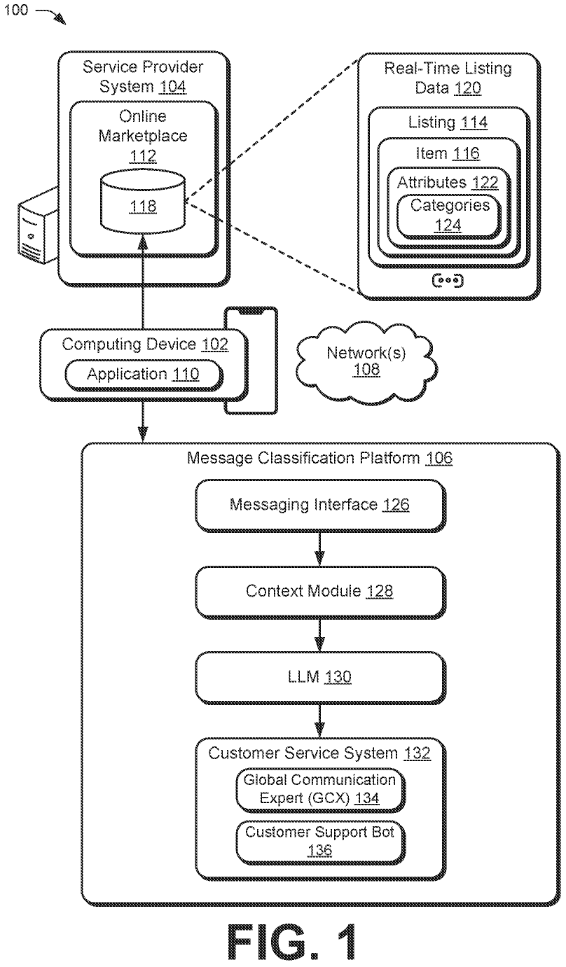

FIG. 1 is an illustration of an environment 100 in an example implementation that is operable to employ techniques described herein. The environment 100 includes a computing device 102, a service provider system 104, and a message classification platform 106. In one or more implementations, the computing device 102, the service provider system 104, and the message classification platform 106 are communicatively coupled, one to another, via network(s) 108. One example of the network(s) 108 is the Internet, although one or more of the computing device 102, the service provider system 104, and the message classification platform 106 may be communicatively coupled using one or more different connections or different networks in various implementations (e.g., a cloud).

Although the message classification platform 106 is depicted in the environment 100 as being separate from the computing device 102 and the service provider system 104, in one or more implementations, an entirety or various portions of the message classification platform 106 are implemented at or by the computing device 102 and/or the service provider system 104. In at least one implementation, for example, at least a portion of the message classification platform 106 is implemented by an application 110 of the computing device 102 and/or using various resources of the computing device 102, such as hardware resources, an operating system, firmware, and so forth. Additionally, or alternatively, at least a portion of the message classification platform 106 is implemented by resources (e.g., server-based storage, processing, and so on) of the service provider system 104. Additionally, or alternatively, at least a portion of the message classification platform 106 is implemented using a third-party service, such as a web services platform that provides one or more hardware and/or other computing resources to support provision of services by web service providers.

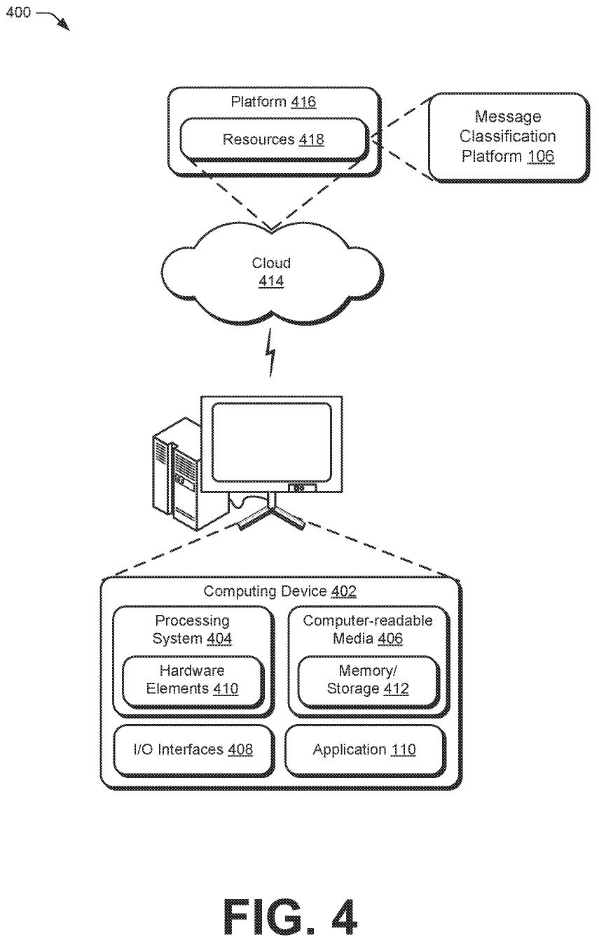

Computing devices that implement the environment 100 are configurable in a variety of ways. A computing device (e.g., computing device 102), for instance, is configurable as a desktop computer, a laptop computer, a mobile device (e.g., assuming a handheld configuration such as a tablet or mobile phone), an Internet-of-Things (IoT) device, a wearable device (e.g., a smart watch, a ring, or smart glasses), an augmented reality (AR)/virtual reality (VR) device (e.g., smart glasses), a server, and so forth. Thus, a computing device ranges from full resource devices with substantial memory and processor resources to low-resource devices with limited memory and/or processing resources. Additionally, although reference is made to a computing device in the singular, a computing device is also representative of a plurality of different devices, such as multiple servers of a server farm or data center utilized to perform operations “over the cloud” as further described in relation to FIG. 4.

In at least one implementation, the application 110 supports communication of data across the network(s) 108, such as between the computing device 102 and the service provider system 104 and/or between the computing device 102 and the message classification platform 106. By supporting such data communication, the application 110 provides a respective user of the computing device 102 (and users of other computing devices) access to online marketplace 112. For example, the computing device 102 receives data from the service provider system 104. Based on the received data, the application 110 causes various systems of the computing device 102 to output user interfaces of the online marketplace 112, such as by displaying user interfaces via display devices or making accessible voice-based user interfaces.

Through interaction of a user with the computing device 102, the application 110 receives user input via one or more user interfaces of the online marketplace 112 and/or message classification platform 106. Examples of such input include, but are not limited to, receiving touch input in relation to portions of a displayed user interface, receiving one or more voice commands, receiving typed input (e.g., via a physical or virtual (“soft”) keyboard), receiving mouse or stylus input, and so forth. One example of the application 110 is a browser, which is operable to navigate to a website of the online marketplace 112, display pages of the website, facilitate user interaction with web pages of the online marketplace 112’s website, and search for listings, items, and/or functionality of the online marketplace 112. Another example of the application 110 is a web-based computer application of the online marketplace 112, such as a mobile application or a desktop application. The application 110 may be configured in different ways, which enable users to interact with their computing devices and by extension perform actions on the online marketplace 112, without departing from the spirit or scope of the techniques described herein.

In one or more implementations, users register with the service provider system 104 to obtain respective user accounts with the online marketplace 112. Such registration may include, for instance, providing an email address and establishing a username and password combination. Subsequent to registering with the service provider system 104, computing devices (e.g., the computing device 102) facilitate signing into, or otherwise authenticating to, the user account in various ways, such as by receiving a username and matching password, receiving biometric information (e.g., at least one image captured of a face or information captured of another body part such as a thumb or finger) that suitably matches stored biometric information associated with the user account, and so forth. In at least some scenarios, however, the user account via which a user accesses the online marketplace 112 may be a guest account that does not require a user to sign in or otherwise authenticate to an already established account before interacting with the online marketplace 112.

Broadly speaking, the online marketplace 112 is configured to generate listings 114 for items 116 and to expose those listings 114 (e.g., publish them) across the network(s) 108 to one or more computing devices, including to the computing device 102. For example, the online marketplace 112 may generate listings 114 for items 116 for sale and expose those listings to computing devices, such that users of the computing devices can interact with the listings via user interfaces to initiate transactions (e.g., purchases, add to wish lists, share, and so on) in relation to the respective item 116 or items 116 of the listings. In accordance with the described techniques, the items 116 include one or more types of physical goods or property (e.g., clothing and/or clothing accessories, jewelry, collectibles, furniture, decorative items, textiles, luxury items, electronics, real property, physical computer-readable storage having one or more video games or other digital content stored thereon, and so on), services (e.g., babysitting, dog walking, house cleaning, home repair, general contracting, and so on), digital items (e.g., digital images, digital music, digital videos) that can be downloaded via the network(s) 108, and blockchain backed assets (e.g., non-fungible tokens (NFTs)), to name just a few.

In the environment 100, the online marketplace 112 includes a storage device 118, which is depicted as maintaining real-time listing data 120. The real-time listing data 120 includes a listings 114 of the online marketplace 112. The storage device 118 may represent one or more databases and/or other types of storage capable of storing the real-time listing data 120. Examples of the storage device 118 include, but are not limited to, mass storage and virtual storage. In one or more implementations, for example, the storage device 118 may be virtualized across a plurality of data centers and/or cloud-based storage devices. The service provider system 104 may implement the online marketplace 112 by using servers that execute stored instructions to deploy various services of the service provider system 104, such that those services perform numerous computations which are effective to provide the functionality described above and below. It is to be appreciated that the online marketplace 112 may include more, fewer, or different components without departing from the spirit or scope described herein.

In one or more implementations, the online marketplace 112 is accessible by decentralized computing devices that correspond to “clients” of the online marketplace 112, e.g., users that have accounts with the online marketplace 112 and/or that access the online marketplace as a “guest” that is not signed to such an account or tracked as a user with an account. In at least some scenarios, but for the provision of accounts and system guardrails implemented by aspects of the online marketplace 112 (e.g., user interfaces of the application 110), the online marketplace 112 does not generally control actions of the users to use functionality of the online marketplace 112 to list items thereon. For instance, a number (e.g., most) of the users of the online marketplace 112 may not be employed by or otherwise similarly controlled by a company associated with the online marketplace 112. In this way, the users of the online marketplace 112 may exert more control over the items 116 listed with the online marketplace 112 (e.g., the items 116 that those users decide to list through the online marketplace 112) than the company associated with the online marketplace 112 (or its employees or agents).

Users that cause items 116 to be listed on the online marketplace 112 may be referred to as “sellers” whereas users that purchase or otherwise obtain items 116 listed on the online marketplace 112 via its listings may be referred to as “buyers.” Sellers and buyers both interact with user interfaces of the online marketplace 112 (e.g., via the application 110) to perform the desired functionality. In addition, an individual user of the online marketplace 112 can interact via the interfaces to be both a seller and a buyer on the online marketplace 112, such as by interacting with the user interfaces to have caused one or more items 116 to be listed on the online marketplace 112 and by interacting with the user interfaces to purchase one or more items 116 from the listings of the online marketplace 112.

A user that is a seller, for instance, may interact with one or more user interfaces of the online marketplace 112 (e.g., output via the application 110) to provide information about one or more items 116 which the seller is causing to be listed on the online marketplace 112. Such user interfaces may include prompts that instruct, or guide, sellers to provide various information about items 116 being listed. Examples of information that such interfaces prompt sellers for and that those sellers provide include, but are not limited to, a title, description (of the item 116), one or more prices (e.g., to purchase the item 116 now and/or a minimum starting bid for the item 116), brand information, size, year, color(s), shipping information (e.g., cost and/or types available), delivery information, return information, payment information, images, videos, models, authenticity information, item history (e.g., chain of custody), and condition (of the item 116), to name a few.

One or more portions of such information may be referred to herein as attributes 122 of the listing 114. For example, a title of the listing 114 may be an attribute 122 of the listing, a description of the item 116 being listed may be an attribute 122 of the listing 114, one or more images uploaded or selected for the listing 114 may be one or more attributes 122 of the listing 114, color(s) of the item 116 may be an attribute 122 of the listing 114, one or more categories 124 (e.g., product or item classes) of the item 116 may be attributes 122 of the listing 114, and so forth. The categories 124 may provide a way to organize inventory of the online marketplace.

In one or more implementations, the categories 124 of the online marketplace 112 include a category hierarchy (e.g., a tree structure) in which more specific child categories 124 (e.g., smartphones) fall under more generic parent categories 124, e.g., electronics. Additionally, or alternatively, the categories 124 of the online marketplace 112 include a plurality of sector categories 124 (e.g., sports) each including one or more highest-level or root categories 124 (e.g., sports memorabilia, sporting goods). Given this, the categories 124 associated with a listing 114 for an item 116 can include the categories 124 of the category hierarchy that the item 116 falls under (e.g., from the root category 124 to the lowest-level or leaf category 124), and one or more sector categories 124 to which the item 116 belongs.

In one or more implementations, the online marketplace 112 saves and maintains the input information for a listing 114 in the storage device 118 in fields of a data structure or data record populated for the listing 114, where a given field and the information populated and maintained for the given field correspond to a particular attribute 122 of the listing 114. For instance, a ‘title’ field of such a data structure or data record may be populated with information (e.g., text) input into a user interface by a seller of a listing 114. The title field and the information input by the user as the title of the listing 114 correspond to an attribute 122 of the listing 114, e.g., a title attribute. In one or more implementations, one or more of the attributes 122 of a listing 114 may be derived and then populated by the online marketplace 112, such as by the online marketplace 112 processing one or more portions of the information input by a user to populate one or more respective attributes of the listing 114.

The message classification platform 106 supports detection and prevention of seller manipulation of buyers as described herein. The message classification platform 106 supports a messaging interface 126 which may allow the seller and the buyer to communicate after a transaction occurs. For example, after the buyer purchases an item 116 from the seller, the seller and the buyer may use to communicate about order details (e.g., confirm customizations or shipping information).

However, the messaging interface 126 also creates opportunities for seller manipulation of buyers, such as coercing buyers to cancel orders, revise feedback, or accept alternative items 116. For example, via messaging, sellers may avoid rating penalties and protect their ratings by shifting responsibility for cancellations to buyers, maximize profits by manipulating buyers to cancel lower-value transactions to sell to higher bidders, and protect seller reputation by influencing buyers to revise feedback using bribes or emotional appeals. Additionally, or alternatively, sellers may discourage legitimate returns to reduce returns or refunds they must issue and avoid financial losses, exploit platform loopholes by using unverifiable excuses such as stock or shipping issues, gain competitive advantage over other sellers by securing higher ratings for better visibility and trust, and deceive buyers to cover the cost of inventory or shipping problems to mask operational issues.

Such seller manipulation may erode buyers’ trust and confidence in the fairness and reliability of the online marketplace 112 by creating negative experiences for the buyers. For example, when sellers misuse the messaging interface to inflate ratings or mislead buyers, the sellers distort buyer feedback and limit fairness of the online marketplace 112. These negative, post-transaction experiences may drive buyers away from the online marketplace 112, directly impacting the user base and revenue of the online marketplace 112. Seller manipulation through the messaging interface 126 may also undermine the reputation of the online marketplace 112 as a trustworthy platform, potentially resulting in competitive disadvantage.

There are numerous types of seller manipulation that may occur via the messaging interface 126. For example, a seller may send a message that coerces a buyer to cancel a transaction for selective selling. That is, sellers with limited stock of an item 116, often a single item 116, may persuade earlier buyers to cancel their transactions, claiming false reasons such as unavailability or product defects. This allows the seller to reserve the item 116 for other buyers that may be willing to pay more. The seller may use this tactic in messages, such as “I’m sorry, but the item is no longer available due to a platform glitch. Could you cancel the transaction?”, “I noticed an issue with inventory—please cancel so I can process a refund quickly,” “The shipping company doesn’t deliver to your location. Please cancel the order from your side,” “Unfortunately, the item is out of stock. It seems there was a glitch in the system,” or “I found an issue with the product quality, so I cannot ship it to you. Please cancel the order.” In such cases, the buyer loses a fair purchase opportunity as the seller prioritizes higher-paying buyers, experiences frustration due to wasted time and effort, especially when the seller relists the item 116 at a higher price, and loses confidence in the integrity and fairness of the online marketplace 112.

Another type of seller manipulation occurs when sellers manipulate feedback for positive ratings. In such cases, sellers may offer incentives or downplay issues to persuade buyers into leaving favorable reviews or revising neutral or negative feedback. The seller may use this type of manipulation in a message, such as “If you leave a 5-star review, I’ll send you a discount coupon for your next purchase,” “I noticed your review was neutral—if you change it to 5 stars, I can offer you a small refund,” “I see you left a 3-star review. It was a minor delay—can you update it to reflect the great quality of the item?”, or “I’m working hard to improve; could you revise your review to a 5-star rating?” These practices may coerce buyers into providing dishonest feedback, undermining their genuine experience. Additionally, this type of manipulation may result in unreliable seller ratings, distorted future buyer decisions, and reduced seller accountability.

Another type of seller manipulation occurs when sellers pressure buyers to avoid submitting returns. Sellers may discourage legitimate returns to avoid penalties by making the process seem inconvenient, costly, or not worthwhile. A seller may exploit a buyer’s preference for a hassle-free experience, pushing the buyer to accept partial resolutions or keep defective items 116. For example, the seller may create an inconvenience by messaging the buyer, “Returning the item will take a long time—how about I refund you 20% instead?” To highlight costs, the seller may message the buyer, “The return shipping cost isn’t covered; are you sure you want to go through with it?” To offer incentives, the seller may message the buyer, “I’ll send you a free item in the future if you keep this one.” This type of manipulation may result in financial loss and reduced trust in sellers from buyers, who likely retain defective or unsatisfactory items 116 in these scenarios.

Another type of seller manipulation occurs when sellers promise some future benefit to a buyer for the buyer’s compliance with some instruction. Sellers may lure buyers into compliance by offering promises such as future discounts, rewards, or premium services. Such offers may exploit a buyer’s immediate gain while masking the seller’s intention to evade accountability for poor service or product quality. By manipulating buyers in this way, sellers may avoid penalties and negative reviews and instead maintain their ratings, however, this tactic undermines the buyer’s trust and perpetuates unfair practices on the online marketplace 112. Examples of a seller’s message using this type of manipulation include “If you cancel the return, I’ll offer you a 50% discount on your next purchase,” or “Please remove the negative review, and I’ll ship your next order with expedited delivery for free.” In such cases, buyers may comply to gain short-term benefits, perpetuating seller manipulation and diminishing trust in seller reliability over time.

Another type of seller manipulation occurs when sellers use urgency and emotional appeals to coerce buyers to perform some action. Sellers may exploit fabricated urgency, emotional appeals, or lies (e.g., personal emergencies) to pressure buyers into canceling transactions, revising negative or neutral feedback, or avoiding returns. These tactics may manipulate buyer sentiment and decision-making to a seller’s advantage. For example, a seller may use false urgency in a message to the buyer, such as “I need you to cancel within the next hour to process the refund quickly,” “This is your last chance to resolve the issue today—please cancel the transaction now,” or “I can only offer you the replacement at this price if you cancel immediately.”

The seller may use emotional appeals in messages, such as “I’m a small business owner, and a bad review would hurt me deeply. Could you leave a good review instead?”, “This is my first sale on this platform—please don’t cancel or leave a negative review,” or “I’m already facing penalties on the platform, please don’t file a return or complaint.” The seller may also lie about family emergencies in messages, such as “I can’t ship the item due to a family emergency. Please cancel the transaction,” or “I’m traveling outside the country and can’t ship the item until next month. Please cancel the order.” In such cases, buyers may feel pressured or guilted into acting against their best interests, feel dissatisfied with unresolved problems, and lose trust in the online marketplace 112.

To mitigate seller manipulation of any form on the online marketplace, the message classification platform 106 may analyze messages sellers send to buyers via the messaging interface. The message classification platform 106 may intercept or receive such a message from the messaging interface 126. A context module 128 may generate a context for the message based on data from multiple sources. The context module 128 may be an example of a natural language processor (NLP), a classifier model, a deep learning model or other types of AI or machine learning models trained to generate a context based on data from multiple sources.

The context may include the seller’s messaging or chat history with this and other buyers. Additionally, or alternatively, the context may include the listing 114 for the item 116 the message is in relation to, including an item description, price, condition, and so forth. Additionally, or alternatively, the context may include the seller’s cancellation history (e.g., seller order fulfilling cancellation history), which may refer to how often the seller has cancelled orders in the past, and under what conditions. Additionally, or alternatively, the context may include past seller behavior metrics, including whether the seller has sent manipulative messages in the past. Additionally, or alternatively, the context may include item bidding history, that is, how many potential buyers bid on the item before the item was sold. Additionally, or alternatively, the context may include the seller’s shipping history (e.g., seller shipping to location history), including where the seller has shipped items in the past.

Based on the examples of the types of seller manipulation described above, the context module 128 may generate different types of contexts. For example, if the message coerces a buyer to cancel a transaction, the context module 128 may generate a cancelation context that substantiates the seller’s behavior regarding canceled transactions. If the seller’s message attempts to manipulate buyer feedback for positive ratings, the context module 128 may generate a feedback context that relates specifically to the seller’s behavior regarding feedback, reviews, and rating. By way of another example, if the seller attempts to pressure a buyer to avoid submitting a return, the context module 128 may generate a return context related to whether the seller typically pressures buyers in this way. If the seller attempts to promise some future to a buyer for their compliance, the context module 128 may generate a context related to seller exploitation, which may describe whether the seller has similarly made promises to buyers in past transactions. If the seller uses urgency or emotional appeals to coerce buyers into performing some action, the context module 128 may generate an urgency context that may substantiate the seller’s behaviors regarding false urgency and emotional appeals.

The message and the context may be provided to an LLM 130, which may be trained to classify an intention of messages. The LLM 130 may be an example of a multi-modal model (e.g., capable of processing different forms of data such as text and image data), open-source AI models, or any other type of LLM. The LLM 130 may be trained on real-time listing data 120 and messages that include manipulative language or content. Based on the content of the message and the context generated by the context module 128, the LLM 130 may classify the message as manipulative. As such, the message classification platform 106 may prevent the message from being sent to the buyer.

The LLM 130 may flag suspicious patterns for buyer or customer support intervention. Messages that the LLM 130 classifies as manipulative may be provided to a customer service system 132. The customer service system 132 may support human customer service agents, including a GCX 134, and AI-based customer service agents, including a customer support bot 136. The GCX 134 or the customer support bot 136 may communicate with the seller to change the message such that the message is no longer manipulative. When the message is no longer manipulative, then the seller may send the message to the buyer and proceed with post-transaction communications. In this way, the customer service system 132 may notify sellers of detected issues with their messages and promote corrective actions and ethical practices.

Having considered an example of an environment, consider now a discussion of some example details of the techniques for AI-based detection and prevention of seller manipulation of buyers in accordance with one or more implementations.

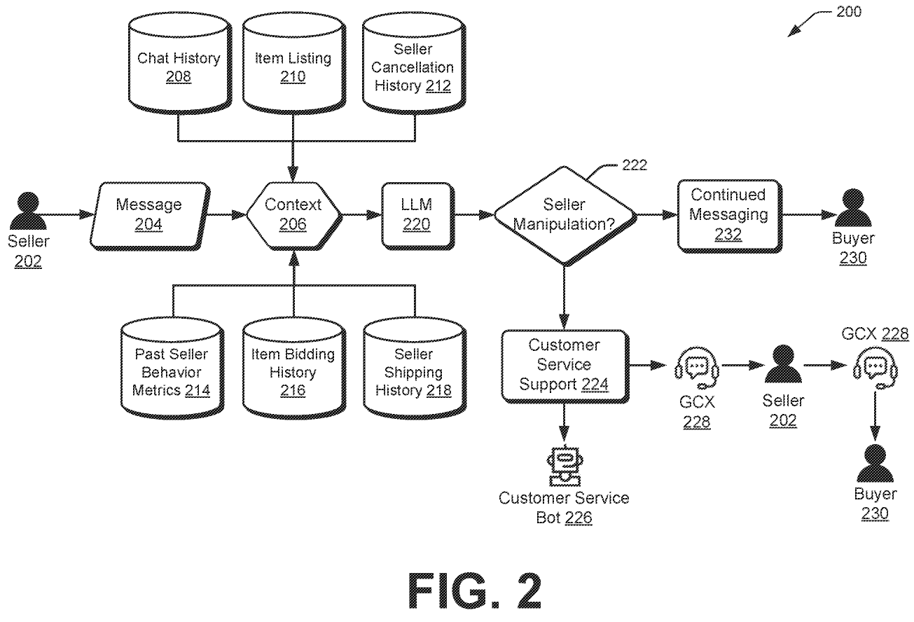

FIG. 2 depicts an example of a process 200 for AI-based detection and prevention of seller manipulation of buyers in accordance with aspects of the present disclosure. The process 200 may be implemented in or otherwise supported by the computing device 102, the service provider system 104, and the message classification platform 106, as described in FIG. 1. For example, the process 200 may be implemented and supported by a context module and an LLM 220, which may be an example of the LLM 130 described in FIG. 1.

As described with reference to FIG. 1, a seller 202 may transact with a buyer 230 on an online marketplace. For example, the buyer 230 may purchase an item from the seller 202. After the transaction, the seller 202 may wish to contact the buyer 230 about the order (e.g., to confirm shipping information or ask about a customization), so the seller 202 may message with the buyer 230 accordingly. Sometimes, however, the seller 202 may write a message 204 to send to the buyer 230 to manipulate the buyer 230 in some way. To prevent such manipulation, a system supported by the online marketplace may intercept the message 204 before the message 204 is received by the buyer 230.

The message 204 itself and information about the seller 202 may be used to generate a context 206 for the message 204. The context 206 may enriched by data from multiple sources in order to determine whether the message 204 includes some manipulative content. The context 206 may include one or more of chat history 208, an item listing 210, a seller cancellation history 212, past seller behavior metrics 214, an item bidding history 216, the seller shipping history 218, and any other data associated with the seller’s activities on the online marketplace.

The chat history 208 may include previous messages between the seller 202 and the buyer 230 about this particular transaction and item. In some examples, the chat history 208 may also include a previous messages between the seller 202 and the buyer 230 about a different transaction or item, or previous messages between the seller 202 and different buyers about respective transactions. The chat history 208 may provide additional context to the transaction and assist in reviewing conversation patterns for red flags. The chat history 208 may be obtained for the context 206 from a messaging database.

The item listing 210 may correspond to the item the buyer 230 purchased from the seller 202. The item listing 210 may include information about the item such as a description, a title, a price, a quantity, an availability, a condition, images, shipping information, the seller’s location, and so forth. Such information may be useful in verifying information such as stock availability and shipping eligibility. That is, the item listing 210 may help assess whether the message 204 is manipulative, as the seller 202 may include contradictory information in the message 204. For example, if the seller 202 tries to convince the buyer 230 that the item the buyer 230 purchased is no longer available, but the item listing 210 shows multiple items in stock, then the message 204 may be manipulative. Even if the item is sold out on the online marketplace, the item listing 210 may still be stored and retrieved from a database supported by the online marketplace (e.g., the storage device 118 described in FIG. 1).

The seller cancellation history 212 (e.g., seller order fulfilling cancellation history or cancellation velocity) may indicate the seller’s historic cancellation trends across all transactions. Specifically, the seller cancellation history 212 may indicate how many transactions a seller 202 has attempted to have buyers cancel (e.g., using manipulative tactics) or that the seller 202 has cancelled themselves. This may include metadata, associated with the cancellations, such as any messages sent between the seller 202 and buyer 230, reasons why the seller 202 or the buyer 230 cancelled the transaction, and so forth. The seller cancellation history 212 may be stored and retrieved from a database supported by the online marketplace.

The past seller behavior metrics 214 may provide a feedback loop that tracks the seller’s previous manipulative behavior and cross-references reports of unethical tactics from buyers or customer support agents. The past seller behavior metrics 214 may include data related to prohibited seller activities and reports submitted against the seller 202 by buyers. For example, a buyer may report the seller 202 if the buyer receives a damaged item or never receives a purchased item. Other reported activities may include past manipulative messages. As such, the past seller behavior metrics 214 may keep track of the seller’s reported behavior, which may help identify any repeated patterns (particularly of manipulation). The past seller behavior metrics 214 may be stored and retrieved from a database supported by the online marketplace.

The item bidding history 216 may include information about bidding activity on the seller’s page, specifically how many potential buyers bid on the item before the buyer 230 ultimately purchased it. This information may allow the system to check if higher bids were received after the current transaction, particularly for limited-stock items. For example, the seller 202 may list two of the same items. The buyer 230 may bid on and purchase one of the two items. However, the seller 202 may receive higher bids on the second of the two items and ultimately sell the same item for more money. In response, the seller 202 may send the message 204 in an attempt to convince the buyer 230 to cancel their order such that the seller 202 may sell the limited-stock item to a subsequent buyer for a higher price. The item bidding history 216 may help indicate whether the seller 202 is trying to manipulate the buyer 230 in this way. The item bidding history 216 may be stored and retrieved from a database supported by the online marketplace.

The seller shipping history 218 (e.g., seller shipping to location history) may include data about where the seller 202 has previously shipped items to. The seller shipping history 218 may indicate where the seller 202 is sending the purchased item from, and locations where the seller 202 may be unable to send the item. For example, if the seller 202 is based in the continental United States, the seller 202 may refrain from shipping the items to Alaska or Hawaii. In addition, the seller shipping history 218 may be used to validate if the seller has shipped to the buyer’s location previously. For example, if the seller 202 includes in the message 204 that the seller 202 is unable to ship the purchased item to the buyer 230 in California, however the seller shipping history 218 indicates that the seller 202 has shipped numerous items to California in the past, such behavior may indicate that the message 204 is manipulative. This information may be gathered from the item listing 210 and other metadata associated with the seller’s account.

The context 206 and the content of the message 204 itself may be sent to an LLM 220, which may be trained to classify the intention of messages. That is, the LLM 220 may use the context 206 and the content of the message 204 to determine if the message 204 includes seller manipulation 222 (e.g., coercion, false urgency, incentivized revision, and so forth). By way of example, if the message 204 indicates that the item the buyer 230 purchased is out of stock, the LLM 220 may utilize the item listing 210 to determine whether that item is actually out of stock. If not, then the message 204 may be classified as manipulative.

By way of another example, if the seller 202 writes in the message 204 that they are unable to ship the item to the buyer’s location, then the LLM 220 may use the seller shipping history to determine whether the seller 202 has shipped to that location in the past. If the seller 202 has never shipped to that location, then the message 204 may be genuine, however, if the seller 202 has shipped to that location in the past, especially frequently, then the message 204 may be classified as manipulative. That is, the LLM 220 may use the context 206 to detect the seller’s intent in the message 204. By way of another example, if the message 204 is similar to other messages the seller 202 has sent in the past, as indicated in the past seller behavior metrics 214, the LLM 220 may classify the message 204 as manipulative based on a repeat behavior. By using the context 206, the LLM 220 not only identifies manipulative behaviors, but also dynamically adapts based on evolving patterns, ensuring proactive and scalable intervention.

If the LLM 220 determines that the message 204 is not manipulative, then the platform may allow for continued messaging 232, where the message 204 is sent to the buyer 230. Referring to the example above, if the message 204 indicates that the seller 202 cannot ship to the buyer’s location and the seller shipping history 218 indicates that indeed the seller 202 has never shipped to the buyer’s location, then the intention of the message 204 may be genuine. For example, the seller 202 may not have known the buyer’s location until after the transaction, where the seller 202 may have mistakenly left accurate shipping information off the item listing 210.

Alternatively, the LLM 220 may classify the message 204 as manipulative. In some examples, the LLM 220 may determine a value that represents a level of manipulation of the message, where the value may be a score, a percentage, or other numerical value. For example, the LLM 220 may classify the message 204 as manipulative if the LLM 220 determines that more than 50% of the content of the message 204 is manipulative. In another example, a manipulative message may correspond to a score of five or higher on a scale from zero to ten (e.g., zero representing the least manipulative, ten representing the most manipulative). Additionally, or alternatively, the LLM 220 may output a confidence score (e.g., as a percentage) indicating how confident the LLM 220 is in its classification of the message 204. For example, the LLM 220 may output a confidence score of 90%, indicating that the LLM 220 is 90% confident that the message 204 is manipulative.

In some examples, the LLM 220 may output a reason as to why the message 204 is classified as manipulative. In doing so, the LLM 220 may identify a category of manipulation, as described in FIG. 1. For example, the LLM 220 may indicate that the message 204 is manipulative for coercing buyers to cancel transactions for selective selling, manipulating feedback for positive ratings, pressuring buyers to avoid returns, promising future benefits for compliance, or using urgency and emotional appeals to coerce buyer actions.

If the LLM 220 classifies the message 204 as manipulative, the message 204 may be provided to customer service support 224 for processing. In some examples, the message 204 may be sent to the customer service support 224 based on the score or percentage of manipulation determined by the LLM 220. For example, messages with scores higher than 90% may automatically be prevented from being sent to the buyer 230, but messages with scores below 90% may be manually reviewed.

The customer service support 224 may include a human customer service agent, such as a GCX 228, and a customer service bot 226 (e.g., an AI-based chatbot). In some examples, the GCX 228 may manually review the message 204 and confirm or disagree with the classification from the LLM 220. For example, the GCX 228 may provide input permitting the message 204 to be sent to the buyer 230 based on their own determination that the message 204 is not manipulative. In such cases, the message 204 may be sent to the buyer 230 based on the GCX’s input. Alternatively, communications between the seller 202 and the buyer 230 may be disabled as soon as the message 204 is classified as manipulative. However, when the GCX 228 instead permits the message 204, then the communications between the seller 202 and the buyer 230 may be reenabled. The manual input from the GCX 228 or other customer service agents that review the message 204 may be used to further train and improve the LLM 220.

In some implementations, the GCX 228 may communicate with the seller 202 regarding the message 204 to determine whether the LLM 220 properly classified the message 204 as manipulative. For example, the GCX 228 may discuss the transaction and what the seller 202 is hoping to achieve in sending the message 204. If the message 204 is clearly being sent for a manipulative purpose and cannot be remedied, then the GCX 228 may prevent the message 204 from being sent to the buyer 230, and communications between the seller 202 and the buyer 230 may be suspended. Alternatively, after messaging back and forth with the GCX 228, the seller 202 may rewrite the message 204 in such a way that the message is no longer manipulative. In such cases, the GCX 228 may enable the message 204 to be sent to the buyer 230.

Additionally, or alternatively, the seller 202 may have similar communications with the customer service bot 226 to remove the manipulative content from the message 204. For example, if the content of the message 204 is relatively simple or common, the message 204 may be processed by the customer service bot 226 instead of the GCX 228, although communications with the seller 202 may be similar. For example, the GCX 228 and the customer service bot 226 may both use a set of rules or standards to determine whether the message 204 is manipulative. The communications between the seller 202 and the customer service bot 226 may also be used to further train and improve the LLM 220.

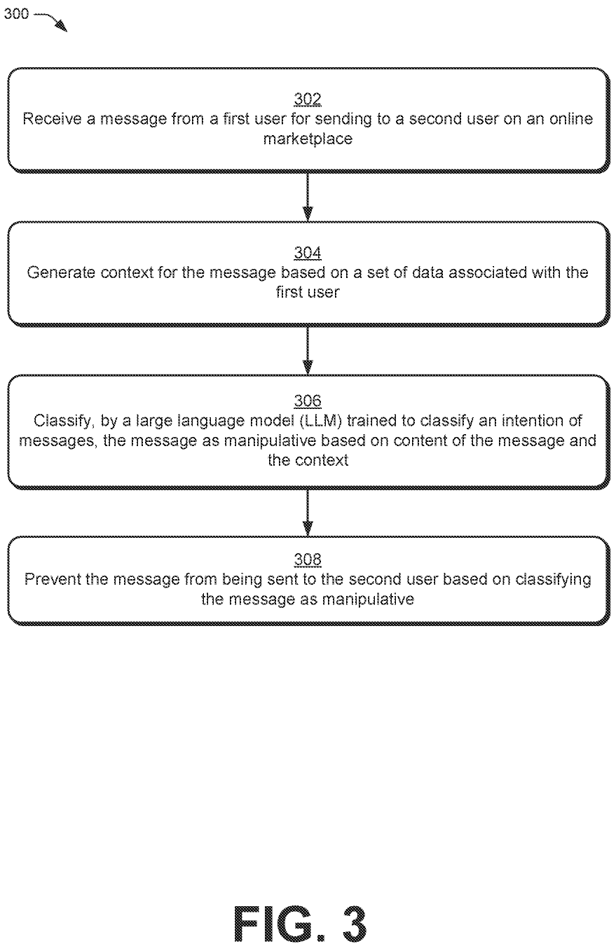

FIG. 3 depicts a procedure 300 in an example implementation of AI-based detection and prevention of seller manipulation of buyers in accordance with aspects of the present disclosure.

A message for sending from a first user to a second user on an online marketplace is received (block 302). By way of example, the first user (e.g., a seller) and the second user (e.g., a buyer) may communicate via a messaging interface 126 after a transaction (e.g., after the buyer purchases an item from the seller). A message classification platform 106 may intercept the message to assess whether the message is manipulative.

Context for the message is generated based on a set of data associated with the first user (block 304). By way of example, the context may include data from multiple sources, including one or more of past message history, item listing details, cancellation velocity, bidding activity, shipping behavior history, past behavior metrics, and other data associated with the first user and this particular transaction.

The message is classified, by an LLM trained to classify an intention of messages, as manipulative based on the content of the message and the context (block 306). By way of example, an LLM 130 may determine that the message is manipulative if the first user used similar manipulation in the past, if the content of the message conflicts with information in the context, and so forth. The LLM 130 may output a score indicating a level of manipulation in the message.

The message is prevented from being sent to the second user based on classifying the message as manipulative (block 308). By way of example, if the message is highly manipulative, communications may be suspended between the first user and the second user. In some other examples, the message may be sent for manual review, where a customer service agent may confirm the classification before sending or refraining from sending the message to the second user.

Having described examples of procedures in accordance with one or more implementations, consider now an example of a system and device that can be utilized to implement the various techniques described herein.

FIG. 4 illustrates an example of a system 400 generally that includes an example of a computing device 402 that is representative of one or more computing systems and/or devices that may implement the various techniques described herein. This is illustrated through inclusion of the application 110 and the message classification platform 106. The computing device 402 may be, for example, a server of a service provider, a device associated with a client (e.g., a client device), an on-chip system, and/or any other suitable computing device or computing system.

The example computing device 402 as illustrated includes a processing system 404, one or more computer-readable media 406, and one or more I/O interfaces 408 that are communicatively coupled, one to another. Although not shown, the computing device 402 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 404 is representative of functionality to perform one or more operations using hardware. Accordingly, the processing system 404 is illustrated as including hardware elements 410 that may be configured as processors, functional blocks, and so forth. This may include implementation in hardware as an application specific integrated circuit or other logic device formed using one or more semiconductors. The hardware elements 410 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 406 is illustrated as including memory/storage 412. The memory/storage 412 represents memory/storage capacity associated with one or more computer-readable media. The memory/storage 412 may include volatile media (such as random access memory (RAM)) and/or nonvolatile media (such as read only memory (ROM), Flash memory, optical disks, magnetic disks, and so forth). The memory/storage 412 may include fixed media (e.g., RAM, ROM, a fixed hard drive, and so on) as well as removable media (e.g., Flash memory, a removable hard drive, an optical disc, and so forth). The computer-readable media 406 may be configured in a variety of other ways as further described below.

Input/output interface(s) 408 are representative of functionality to allow a user to enter commands and information to computing device 402 and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 402 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 402. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 402, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 410 and computer-readable media 406 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 410. The computing device 402 may be configured to implement particular instructions and/or functions corresponding to the software and/or hardware modules. Accordingly, implementation of a module that is executable by the computing device 402 as software may be achieved at least partially in hardware, e.g., through use of computer-readable storage media and/or hardware elements 410 of the processing system 404. The instructions and/or functions may be executable/operable by one or more articles of manufacture (for example, one or more computing devices 402 and/or processing systems 404) to implement techniques, modules, and examples described herein.

The techniques described herein may be supported by various configurations of the computing device 402 and are not limited to the specific examples of the techniques described herein. This functionality may also be implemented all or in part through use of a distributed system, such as over a “cloud” 414 via a platform 416 as described below.

The cloud 414 includes and/or is representative of a platform 416 for resources 418. The platform 416 abstracts underlying functionality of hardware (e.g., servers) and software resources of the cloud 414. The resources 418 may include applications and/or data that can be utilized while computer processing is executed on servers that are remote from the computing device 402. Resources 418 can also include services provided over the Internet and/or through a subscriber network, such as a cellular or Wi-Fi network.

The platform 416 may abstract resources and functions to connect the computing device 402 with other computing devices. The platform 416 may also serve to abstract scaling of resources to provide a corresponding level of scale to encountered demand for the resources 418 that are implemented via the platform 416. Accordingly, in an interconnected device embodiment, implementation of functionality described herein may be distributed throughout the system 400. For example, the functionality may be implemented in part on the computing device 402 as well as via the platform 416 that abstracts the functionality of the cloud 414.

### Conclusion

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A computer-implemented method comprising:
receiving a message from a first user for sending to a second user on an online marketplace;
generating context for the message based on a set of data associated with the first user;
classifying, by a large language model (LLM) trained to classify an intention of messages, the message as manipulative based on content of the message and the context; and
preventing the message from being sent to the second user based on classifying the message as manipulative.

2. The computer-implemented method of claim 1, further comprising:
providing the message for processing by a customer service agent based on classifying the message as manipulative; and
determining, by the customer service agent, whether the message is properly classified as manipulative.

3. The computer-implemented method of claim 2, further comprising:
receiving, from the customer service agent, input permitting the message to be sent to the second user; and
sending the message to the second user based on the input.

4. The computer-implemented method of claim 3, further comprising:
disabling communications between the first user and the second user based on classifying the message as manipulative; and
reenabling the communications between the first user and the second user based in the input permitting the message to be sent.

5. The computer-implemented method of claim 2, wherein determining whether the message is properly classified as manipulative comprises communicating, by the customer service agent, with the first user regarding the message.

6. The computer-implemented method of claim 1, wherein the set of data comprises at least one of a chat history of the first user, item listing information associated with the first user, a cancellation history of the first user, past behavior metrics of the first user, an item bidding history associated with the first user, or shipping information associated with the first user.

7. The computer-implemented method of claim 6, wherein the message is classified as manipulative based on the set of data indicating past manipulative behavior by the second user.

8. The computer-implemented method of claim 1, wherein classifying the message as manipulative comprises determining, by the LLM, a value that represents a level of manipulation of the message, wherein the value is a score or a percentage.

9. The computer-implemented method of claim 1, wherein the first user and the second user are involved in a transaction on the online marketplace, and wherein the message is regarding the transaction.

10. A system comprising:
one or more processors; and
memory storing instructions that, when executed by the one or more processors, cause the system to:
receive a message from a first user for sending to a second user on an online marketplace;
generate context for the message based on a set of data associated with the first user;
classify, by a large language model (LLM) trained to classify an intention of messages, the message as manipulative based on content of the message and the context; and
prevent the message from being sent to the second user based on classifying the message as manipulative.

11. The system of claim 10, wherein the instructions further cause the system to:
provide the message for processing by a customer service agent based on classifying the message as manipulative; and
determine, by the customer service agent, whether the message is properly classified as manipulative.

12. The system of claim 11, wherein the instructions further cause the system to:
receive, from the customer service agent, input permitting the message to be sent to the second user; and
send the message to the second user based on the input.

13. The system of claim 12, wherein the instructions further cause the system to:
disable communications between the first user and the second user based on classifying the message as manipulative; and
reenable the communications between the first user and the second user based in the input permitting the message to be sent.

14. The system of claim 11, wherein the instructions to determine whether the message is properly classified as manipulative further cause the system to, communicate, by the customer service agent, with the first user regarding the message.

15. The system of claim 10, wherein the set of data comprises at least one of a chat history of the first user, item listing information associated with the first user, a cancellation history of the first user, past behavior metrics of the first user, an item bidding history associated with the first user, or shipping information associated with the first user.

16. The system of claim 15, wherein the message is classified as manipulative based on the set of data indicating past manipulative behavior by the second user.

17. The system of claim 10, wherein the instructions to classify the message as manipulative further cause the system to determine, by the LLM, a value that represents a level of manipulation of the message, wherein the value is a score or a percentage.

18. The system of claim 10, wherein the first user and the second user are involved in a transaction on the online marketplace, and wherein the message is regarding the transaction.

19. A non-transitory computer-readable media storing instructions that, when executed by one or more processors, cause the one or more processors to perform operations including:
receiving a message from a first user for sending to a second user on an online marketplace;
generating context for the message based on a set of data associated with the first user;
classifying, by a large language model (LLM) trained to classify an intention of messages, the message as manipulative based on content of the message and the context; and
preventing the message from being sent to the second user based on classifying the message as manipulative.

20. The non-transitory computer-readable media of claim 19, wherein the instructions cause the one or more processors to:
provide the message for processing by a customer service agent based on classifying the message as manipulative; and
determine, by the customer service agent, whether the message is properly classified as manipulative.
